(19) United States
(12) Patent Application Publication
(10) Pub. No.: US 2026/0254006 A1
(43) Pub. Date: Aug. 27, 2026

(54) ALL-SOLID STATE BATTERY AND METHOD FOR MANUFACTURING SAME

(71) Applicant: SAMSUNG SDI CO., LTD., Yongin-si, Gyeonggi-do (KR)

(72) Inventors: Minsuk LEE, Yongin-si, Gyeonggi-do (KR); Jaewon KIM, Yongin-si, Gyeonggi-do (KR); Suyeol Ryu, Yongin-si, Gyeonggi-do (KR); Guesung KIM, Yongin-si, Gyeonggi-do (KR); Young Gyoon RYU, Yongin-si, Gyeonggi-do (KR)

(21) Appl. No.: 18/877,379

(22) PCT Filed: Nov. 3, 2023
(86) PCT No.: PCT/KR2023/017513

§ 371 Date: Dec. 20, 2024

(30) Foreign Application Priority Data
Nov. 9, 2022 (KR) 10-2022-0148804

(51) Int. Cl. H01M 50/143; A62C 3/16; H01M 10/0585; H01M 50/536

(52) U.S. Cl. CPC H01M 50/143; A62C 3/16; H01M 10/0585; H01M 50/536

(57) ABSTRACT

A method for manufacturing an all-solid-state battery is provided. A method for manufacturing an all-solid-state battery according to an embodiment includes: a first step of supplying, in a reel type, a counterpart member sheet in which counterpart members, each having a blank corresponding to a positive electrode of a battery cell, are partitioned with repeating pre-cut portions and uncut portions; a second step of arranging a magazine-type positive electrode in the blanks; a third step of supplying, in a reel type, a first solid electrolyte/negative electrode sheet and a second solid electrolyte/negative electrode sheet to upper and lower portions of the counterpart member sheet to which the positive electrode is assembled, each of the first solid electrolyte/negative electrode sheet and the second solid electrolyte/negative electrode sheet being formed by attaching a solid electrolyte and a negative electrode; a fourth step of performing temporary bonding lamination on the first solid electrolyte/negative electrode sheet, the counterpart member sheet to which the positive electrode is assembled, and the second solid electrolyte/negative electrode sheet; and a fifth step of pressing and cutting a temporarily bonded laminated first laminate to separate bi-cells.

### TECHNICAL FIELD

The present invention relates to an all-solid-state battery and a method for manufacturing the same, and more specifically, to an all-solid-state battery applying uniaxial pressing of a battery cell and a method for manufacturing the same.

### BACKGROUND ART

For example, all-solid-state batteries include sulfide-based solid electrolytes and require high-pressure pressing. The pressing process includes warm isostatic press (WIP), which uses liquids, uniaxial plate press (P/P), which uses hydraulic pressure, and roll press (R/P).

In the warm isostatic press, a battery cell is fixed to a metal plate, entirely vacuum-packed, and then pressed. In other words, the warm isostatic press is a form of biaxial pressing and is more suitable for pressing all-solid-state batteries including sulfide-based solid electrolytes compared to other pressing processes.

However, the WIP has two problems. First, the WIP requires packaging and opening of components to be pressed, which results in very low mass productivity. Second, pressing conditions are different between a metal surface and a packaging surface, creating an asymmetric surface in stack pressing or in the stacking of pressed cells, which reduces cell service life.

On the other hand, the P/P and R/P are inherently difficult to review. The physical properties of sulfide-based solid electrolytes before and after pressing are completely different. The solid electrolyte is a soft powder before pressing but, after pressing, becomes similar to a ceramic that breaks easily. Therefore, solid electrolytes are unsuitable materials for cumulative pressing.

When applying the P/P or R/P to such materials, deformation occurs due to uneven pressing. Such deformation causes a short circuit during first charging. The P/P or R/P is a uniaxial pressing method. If the alignment of cell components is asymmetrical, the cell components are not pressed according to a specific ratio and elongate along an axis without applied pressure, and each component has a different elongation rate, making it difficult to uniformly press a multilayer structure.

All-solid-state batteries containing solid electrolytes may be classified into lithium ion intercalation, lithium alloy, and lithium deposition types, depending on the way lithium is accumulated on a negative electrode during charging. In the lithium deposition type, lithium ions precipitate and accumulate as metal on the negative electrode, and lithium metal deposits on the negative electrode during charging, regardless of whether there is an active material on the negative electrode.

Lithium deposition-type all-solid-state batteries use a negative electrode, and this negative electrode does not have a housing (housing-free). In lithium deposition-type all-solid-state batteries, lithium ions migrate from the positive electrode to the negative electrode and deposit on the negative electrode during charging, and dissociate and migrate back to the positive electrode during discharging.

During charging, lithium deposits on the negative electrode, leading to an expansion in the volume of the battery cell. In addition, if no pressure is applied to the battery cell, lithium deposition becomes non-uniform in the free state, and as charging and discharging progress, the non-uniformity increases, potentially causing the solid electrolyte to partially break and leading to a short circuit.

To solve the non-uniformity in pressure of the lithium deposition-type battery cell, a pressure of 2 to 4 MPa is applied to the battery cell. Pure lithium has high reactivity. The lithium deposited on the negative electrode is pure lithium and easily reacts with residual impurities within the battery cell that can vaporize, leading to oxidation.

In the all-solid-state batteries, residual impurities cannot be adsorbed, so when impurities react with lithium, the oxidized lithium becomes unusable during discharging, leading to a reduction in capacity. In addition, if lithium oxide increases locally, lithium oxide has a high elastic modulus, so it can locally apply stress to the solid electrolyte, potentially causing a breakage and a short circuit.

### DISCLOSURE

### Technical Problem

An embodiment provides a method for manufacturing an all-solid-state battery, in which a counterpart member sheet for uniaxial pressing of a battery cell is applied. An embodiment provides a method for manufacturing an all-solid-state battery, which provides a buffering function of a counterpart member sheet, induces uniform pressing for multilayer components inside a battery cell, insulates positive and negative electrodes, and enhances safety of the battery.

An embodiment provides a method for manufacturing an all-solid-state battery, in which a counterpart member sheet and a solid electrolyte/negative electrode are changed from a magazine type to a reel type, a hybrid of a magazine-type positive electrode and a reel to sheet is applied, and a vacuum multi-stage roll press is used, resulting in improved stack processability and productivity.

In addition, an embodiment provides an all-solid-state battery manufactured by the method for manufacturing an all-solid-state battery.

### Technical Solution

A method for manufacturing an all-solid-state battery according to an embodiment includes: a first step of supplying, in a reel type, a counterpart member sheet in which counterpart members, each having a blank corresponding to a positive electrode of a battery cell, are partitioned with repeating pre-cut portions and uncut portions; a second step of arranging a magazine-type positive electrode in the blanks; a third step of supplying, in a reel type, a first solid electrolyte/negative electrode sheet and a second solid electrolyte/negative electrode sheet to upper and lower portions of the counterpart member sheet to which the positive electrode is assembled, each of the first solid electrolyte/negative electrode sheet and the second solid electrolyte/negative electrode sheet being formed by attaching a solid electrolyte and a negative electrode; a fourth step of performing temporary bonding lamination on the first solid electrolyte/negative electrode sheet, the counterpart member sheet to which the positive electrode is assembled, and the second solid electrolyte/negative electrode sheet; and a fifth step of pressing and cutting a temporarily bonded laminated first laminate to separate bi-cells.

The method for manufacturing an all-solid-state battery according to an embodiment may further include a sixth step of alternately laminating the bi-cells and buffer pads to form a second laminate.

The method for manufacturing an all-solid-state battery according to an embodiment may further include a seventh step of welding lead tabs of the positive electrodes to each other and welding lead tabs of the negative electrodes to each other in the second laminate, and inserting the second laminate into a case to complete a stack.

In the first step, the reel-type counterpart member sheet may be supplied with the pre-cut portions on both sides in a direction intersecting an advancing direction of the counterpart member sheet.

In the first step, the counterpart member sheet may be supplied as a single sheet, and in the second step, a lead tab of a positive electrode assembled to the blank of the single sheet may be coupled to a groove of the counterpart member, the positive electrode including positive electrode active materials on both surfaces.

In the second step, an insulating tape may be attached to a side of the lead tab of the positive electrode toward the solid electrolyte.

In the first step, the counterpart member sheet may be supplied as two sheets, and in the second step, a lead tab of a positive electrode assembled to each of the blanks of the two sheets may be coupled to grooves of two counterpart members facing each other and drawn out between the two counterpart members, the positive electrode including positive electrode active materials on both surfaces.

In the fourth step, alignment and then temporary bonding lamination may be performed with a hybrid combination of reel to sheet and magazine.

In the fifth step, the first laminate may be pressed using a roll press.

An all-solid-state battery according to an embodiment includes a bi-cell including a counterpart member having a blank, a positive electrode formed corresponding to the blank of the counterpart member and arranged in the blank, and a solid electrolyte/negative electrode bonded to each other so as to be adhered to the positive electrode with a solid electrolyte, wherein the counterpart member includes an outer separation portion separated by a cut connecting a pre-cut portion and an uncut portion in an uncut state.

The all-solid-state battery according to an embodiment may include a laminate including a plurality of the bi-cells and a plurality of buffer pads and formed by alternately laminating the bi-cells and the buffer pads.

In the laminate, lead tabs of the positive electrodes may be welded to each other, and lead tabs of the negative electrodes may be welded to each other.

The counterpart member may include the pre-cut portions on both sides in a direction in which a lead tab of the positive electrode and a lead tab of the negative electrode are drawn out and on both sides in a direction intersecting the drawing direction, and may include the separation portion at corners intersecting outer edges connecting to the pre-cut portions.

The counterpart member may be formed as a single member, the positive electrode may include positive electrode active materials on both surfaces and may be assembled to the blank, and a lead tab of the positive electrode may be coupled to a groove of the counterpart member and bent.

The lead tab of the positive electrode may further include an insulating tape attached to a side toward the solid electrolyte.

The counterpart member may be formed as two members, the positive electrode may include positive electrode active materials on both surfaces and may be assembled to the blank, and a lead tab of the positive electrode may be coupled to grooves of the two counterpart members facing each other and drawn out between the two counterpart members.

The counterpart member may further include an adsorption flame retardant film including a pulp fiber, a glass fiber, Al(OH)3, and a binder.

The binder may include at least one of H-NBR, PVDF-HFP, and polyacrylate.

The adsorption flame retardant film may be coated on both surfaces of the counterpart member.

A content of the binder may be 1 to 20 wt %. A content of the binder may be 5 to 10 wt %.

### Advantageous Effects

In an embodiment, a counterpart member sheet for assembling a positive electrode is applied, allowing uniaxial pressing of a battery cell.

In an embodiment, a counterpart member sheet is applied, thereby providing a buffering function by a counterpart member, inducing uniform pressing for multilayer components inside a battery cell, implementing insulation between a positive electrode and a negative electrode, and enhancing safety of a battery.

In an embodiment, a counterpart member sheet and a solid electrolyte/negative electrode are applied in a reel type and a magazine-type positive electrode is applied, allowing for improved stack processability and productivity through pressing with a vacuum multi-stage roll press.

### DESCRIPTION OF THE DRAWINGS

FIG. 1 is a flow chart of a method for manufacturing an all-solid-state battery according to an embodiment of the present invention.

FIG. 2 is a plan view showing a first step of supplying a counterpart member sheet in the method for manufacturing an all-solid-state battery.

FIG. 3A is a plan view showing a second step of assembling a positive electrode to a blank of a counterpart member sheet, and FIG. 3B is a plan view showing a third step of supplying a solid electrolyte/negative electrode sheet formed by attaching a solid electrolyte and a negative electrode.

FIG. 4A is a plan view showing a fourth step of performing temporary bonding lamination on a first solid electrolyte/negative electrode sheet, a counterpart member sheet to which the positive electrode is assembled, and a second solid electrolyte/negative electrode sheet, and FIG. 4B is a side view thereof.

FIG. 5A is a plan view of a positive electrode, FIG. 5B is a cross-sectional view of the positive electrode before assembly, FIG. 5C is a cross-sectional view of the positive electrode after assembly, and FIG. 5D is an enlarged view of the positive electrode.

FIG. 6 is a plan view showing a step of pressing a first laminate including the first solid electrolyte/negative electrode sheet, the counterpart member sheet to which the positive electrode is assembled, and the second solid electrolyte/negative electrode sheet, which are temporarily bonded.

FIG. 7A is a plan view showing a process of separating the pressed first laminate into a bi-cell, and FIG. 7B is a plan view of the separated bi-cell.

FIG. 8 is an exploded perspective view of an arrangement in which buffer pads are provided on both surfaces of a separated bi-cell.

FIG. 9 is a cross-sectional view of an all-solid-state battery according to a first embodiment of the present invention including the bi-cell and buffer pads of FIG. 8.

FIG. 10 is a cross-sectional view of an all-solid-state battery according to a second embodiment of the present invention.

### MODE FOR INVENTION

The present invention will be described more fully hereinafter with reference to the accompanying drawings, in which embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

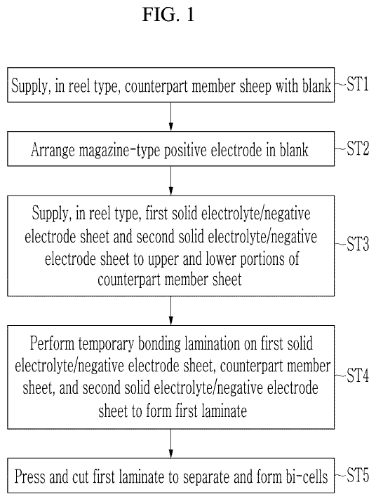

FIG. 1 is a flow chart of a method for manufacturing an all-solid-state battery according to an embodiment of the present invention. Referring to FIG. 1, the method for manufacturing an all-solid-state battery according to an embodiment includes a first step (ST1), a second step (ST2), a third step (ST3), a fourth step (ST4), and a fifth step (ST5).

An embodiment enables preemptive blocking of the effects of physical defects that cause short circuits in all-solid-state batteries. Therefore, an embodiment can implement improved charge/discharge cycle life, prevention of sudden drop in battery capacity due to short circuit, cost reduction, and enhanced mass productivity.

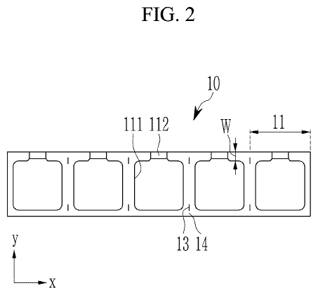

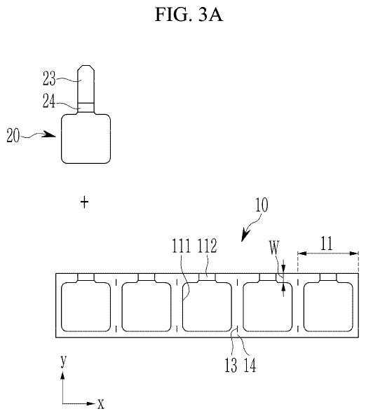

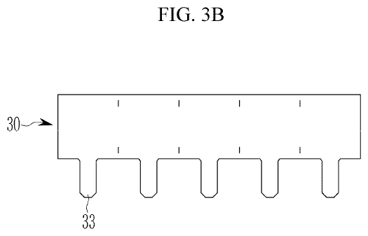

FIG. 2 is a plan view showing a first step of supplying a counterpart member sheet in the method for manufacturing an all-solid-state battery. Referring to FIGS. 1 and 2, in the first step (ST1), a counterpart member sheet 10 is supplied in a reel type.

The counterpart member sheet 10 includes counterpart members 11 each having a blank 111 corresponding to a positive electrode 20 of a battery cell. In the counterpart member sheet 10, the counterpart members 11 are partitioned with repeating pre-cut portions 13 and uncut portions 14. That is, the pre-cut portion 13 is provided between the neighboring counterpart members 11.

In the first step 1 (ST1), the reel-type counterpart member sheet 10 is supplied with the pre-cut portions 13 on both surfaces in a direction (y-axis direction) intersecting an advancing direction (x-axis direction) of the counterpart member sheet 13. The counterpart member 11 between the pre-cut portion 13 and the blank 111 has a width (W) set in the y-axis direction or the x-axis direction so as to exhibit buffering performance.

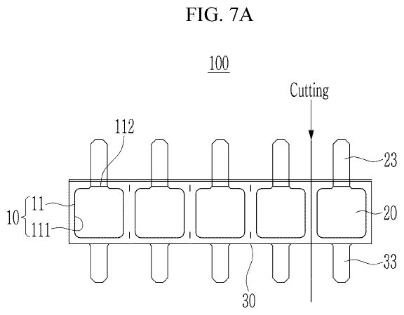

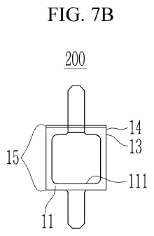

In the counterpart member sheet 10, the counterpart member 11 forms a part of an all-solid-state battery 1, thereby enabling uniform roll pressing. The counterpart member 11 is included in an internal configuration of the all-solid-state battery 1, and suppresses lateral elongation of positive electrode active materials 21 and 22, a solid electrolyte, and a negative electrode active material, and enables uniform roll pressing as a whole. After roll pressing is completed, the uncut portion 14 of the counterpart member 11 is separated by a laser or a mold (see FIG. 7A).

FIG. 3A is a plan view showing a second step of assembling a positive electrode to a blank of a counterpart member sheet, and FIG. 3B is a plan view showing a third step of supplying a solid electrolyte/negative electrode sheet formed by attaching a solid electrolyte and a negative electrode.

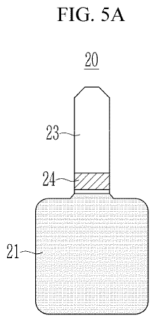

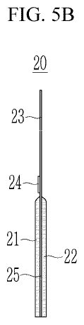

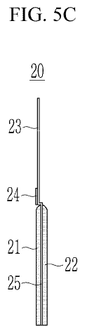

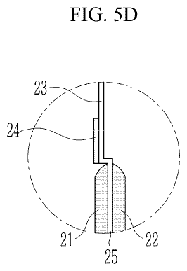

Referring to FIGS. 1, 3A, and 3B, in the second step (ST2), a magazine-type positive electrode 20 is arranged in the blank 111. In the first step 1 (ST1), the counterpart member sheet 10 is supplied as a single sheet. The positive electrode 20 includes positive electrode active materials 21 and 22 (see FIG. 5) on both surfaces of a current collector 25.

In the second step (ST2), a lead tab 23 of the positive electrode 20 assembled to the blank 111 of one sheet is coupled to a groove 112 of the counterpart member 11, and the lead tab 23 is bent due to temporary bonding and pressing. Although not shown, the lead tab may be bent and coupled to the groove. The positive electrode 20 may be pre-pressed and coupled to the blank 111. In addition, in the second step (ST2), an insulating tape 24 is attached to a side of the lead tab 23 of the positive electrode 20 toward a solid electrolyte.

In the third step 3 (ST3), a solid electrolyte/negative electrode sheet 30 formed by attaching a solid electrolyte and a negative electrode is supplied in a reel type. The solid electrolyte/negative electrode sheet 30 includes a first solid electrolyte/negative electrode sheet 31 and a second solid electrolyte/negative electrode sheet 32.

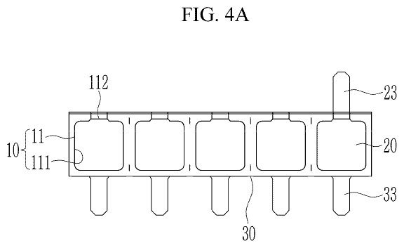

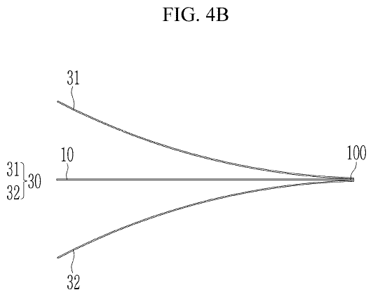

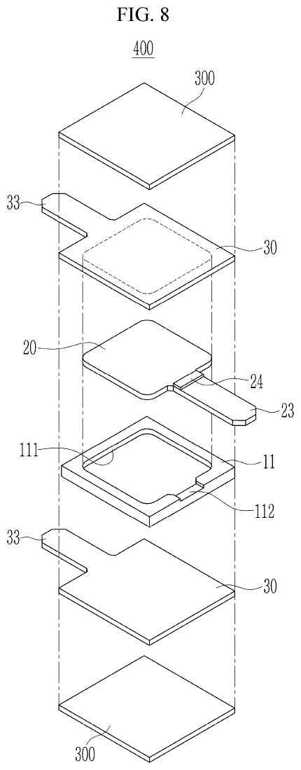

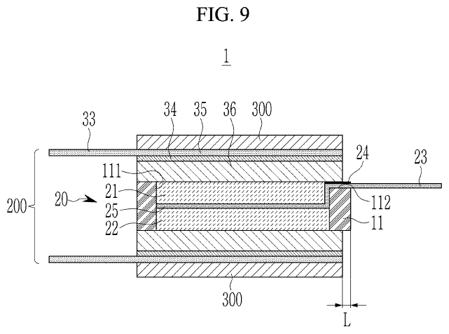

That is, in the third step (ST3), the first solid electrolyte/negative electrode sheet 31 and the second solid electrolyte/negative electrode sheet 32 are supplied in a reel type to upper and lower portions of the counterpart member sheet 10 to which the positive electrode 20 is assembled (see FIGS. 4B and 9).

In a reel-type first laminate 100 of the first solid electrolyte/negative electrode sheet 31, the counterpart member sheet 10 to which the positive electrode 20 is assembled, and the second solid electrolyte/negative electrode sheet 32, the pre-cut portions 13 are each positioned between the counterpart members 11 to serve as a reference line for cutting after temporary bonding and pressing, and a precise punch die or laser may be applied for cutting or separating the first laminate 100.

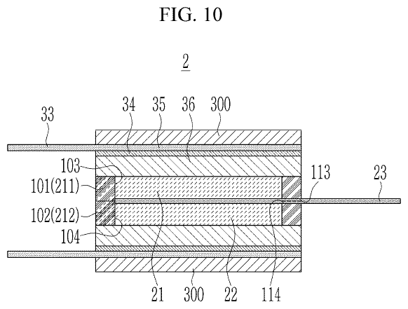

In addition, in the first step (ST1), the counterpart member sheet is supplied as two sheets 211 and 212. In the second step (ST2), the lead tab 23 of the positive electrode 20, which includes the positive electrode active materials 21 and 22 on both surfaces, assembled to each of blanks 103 and 104 of the two sheets is coupled to grooves 113 and 114 of two counterpart members 101 and 102 facing each other and drawn out between the two counterpart members 101 and 102 (see FIG. 10). In this case, the lead tab 23 of the positive electrode 20 is not bent.

FIG. 4A is a plan view showing a fourth step of performing temporary bonding lamination on a first solid electrolyte/negative electrode sheet, a counterpart member sheet to which the positive electrode is assembled, and a second solid electrolyte/negative electrode sheet, and FIG. 4B is a side view thereof.

Referring to FIGS. 1, 4A, and 4B, in the fourth step (ST4), the first solid electrolyte/negative electrode sheet 31, the counterpart member sheet 10 to which the positive electrode 20 is assembled, and the second solid electrolyte/negative electrode sheet 32 are temporarily bonded laminated. In the fourth step 4 (ST4), alignment and then temporary bonding lamination may be performed with a hybrid combination of reel to sheet and magazine.

For example, temporary bonding lamination may be performed at a temperature of 60 to 80° C., a pressure of 2 to 5 MPa, and a rate of 1 to 10 m/min. The temporary bonding lamination process for the first laminate 100 is composed of a hybrid combination of reel to sheet and magazine. The temporary bonding lamination process simplifies alignment and temporary bonding, compared to warm isostatic press (WIP) in a liquid environment.

FIG. 5A is a plan view of a positive electrode, FIG. 5B is a cross-sectional view of the positive electrode before assembly, FIG. 5C is a cross-sectional view of the positive electrode after assembly, and FIG. 5D is an enlarged view of the positive electrode. Referring to FIGS. 5A to 5D, the positive electrode 20 includes positive electrode active materials 21 and 22 on both surfaces of the current collector 25.

The lead tab 23 of the positive electrode 20 is connected to the current collector 25, as an uncoated portion, is bent to form a step when assembled to the blank 111 of one sheet, and is coupled to the groove 112 of the counterpart member 11. An insulating tape 24 is attached to a side of the lead tab 23 of the positive electrode 20 toward the solid electrolyte side to prevent a short circuit with the solid electrolyte/negative electrode 30 (see FIG. 9).

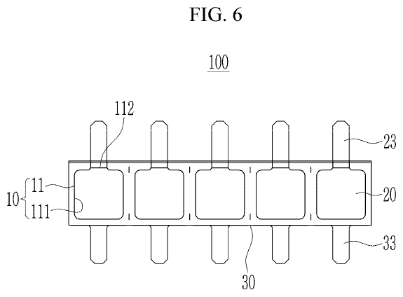

FIG. 6 is a plan view showing a step of pressing a first laminate including the first solid electrolyte/negative electrode sheet, the counterpart member sheet to which the positive electrode is assembled, and the second solid electrolyte/negative electrode sheet, which are temporarily bonded, FIG. 7A is a plan view showing a process of separating the pressed first laminate into a bi-cell, and FIG. 7B is a plan view of the separated bi-cell.

Referring to FIGS. 6, 7A, and 7B, in the fifth step (ST5), the temporarily bonded laminated first laminate 100 is pressed and cut to separate bi-cells 200 from the first laminate 100. For example, in the fifth step (ST5), the first laminate 100 is pressed with a roll press.

The vacuum warm roll pressing for the first laminate 100 may be performed at a temperature of 90 to 150° C., a maximum line pressure of 5 ton/cm, a vacuum level of 1 Torr, and a rate of 1 to 10 m/min, and with a multi-stage roll press. The roll pressing may be performed with 2 to 5 stages of pressing.

After the vacuum multi-stage roll pressing, the first laminate 100 is cut based on the pre-cut portions 13 and separated into bi-cells 200. For the cutting process, a punch-die system or laser punching may be applied.

FIG. 8 is an exploded perspective view of an arrangement in which buffer pads are provided on both surfaces of a separated bi-cell. Referring to FIG. 8, the method for manufacturing an all-solid-state battery according to an embodiment further includes a sixth step (ST6). In the sixth step (ST6), the bi-cells 200 and buffer pads 300 are alternately laminated to form a second laminate 400.

The method for manufacturing an all-solid-state battery according to an embodiment further includes a seventh step (ST7). In the seventh step 7 (ST7), the lead tabs 23 of the positive electrodes 20 are welded to each other and negative electrode lead tabs 33 of the solid electrolyte/negative electrodes 30 are welded to each other in the second laminate 400, and the second laminate 400 is inserted into a pouch or case (not shown) to complete a stack.

The stack forming the all-solid-state battery 1 alternately laminates the bi-cells 200 and buffer pads 300, which may be laminated in 20 to 30 layers.

Below, all-solid-state batteries manufactured using the above-described manufacturing method will be described. FIG. 9 is a cross-sectional view of an all-solid-state battery according to a first embodiment of the present invention including the bi-cell and buffer pads of FIG. 8.

Referring to FIG. 9, the all-solid-state battery 1 of the first embodiment includes a counterpart member 11 having a blank 111, a negative electrode 20 formed corresponding to the blank 111 of the counterpart member 11 and arranged, and a solid electrolyte/negative electrode 30 bonded to each other so as to be adhered to the negative electrode 20 with a solid electrolyte, thereby forming a bi-cell 200.

The counterpart member 11 includes an outer separation portion 15, separated by a cut connecting the pre-cut portion 13 and the uncut portion 14 in an uncut state, and is arranged at the periphery of the positive electrode 20. The counterpart member 11 further includes an adsorption flame retardant film including a pulp fiber, a glass fiber, Al(OH)₃, and a binder.

The glass fiber increases the strength of the pulp fiber, and Al(OH)₃ serves as an H₂O adsorbent below 100° C. and has flame retardancy of a composite material above 160° C. The binder provides binding force and includes at least one of H-NBR, PVDF-HFP, and polyacrylate.

The adsorption flame retardant film is coated on both surfaces of the counterpart member 11. As an example, a content of the binder is 1 to 20 wt %. Additionally, the content of the binder is 5 to 10 wt %. The adsorption flame retardant film can improve the service life of the battery cell by adsorbing residual impurities and improve the safety of the battery cell by applying flame retardant materials.

The counterpart member 11 provides uniform pressing for the solid electrolyte/negative electrode 30 during the vacuum warm roll pressing of the laminated bi-cells 200, and also provides uniform pressing during battery cell evaluation.

The counterpart member 11 removes residual moisture (H₂O) that has entered the aluminum pouch as well as any residual moisture that may be generated during charging and discharging. Additionally, the counterpart member 11 releases moisture (H₂O) at high temperatures above 160° C. due to abuse, preventing the temperature of the battery cell from rising further.

Referring to FIGS. 7A, 7B, and 9, the counterpart member 11 includes the pre-cut portions 13 on both sides in a direction in which the lead tab 23 of the positive electrode 20 and the lead tab 33 serving as a negative electrode uncoated portion of the solid electrolyte/negative electrode 30 are drawn out and on both sides in a direction intersecting the drawing direction, and includes the separation portion 15 at corners intersecting outer edges connecting to the pre-cut portions. That is, the separation portion 15 is formed by being separated from the uncut portion 14.

The counterpart member 11 is formed as a single member, the positive electrode 20 include the positive electrode active materials 21 and 22 on both surfaces and is assembled to the blank 111, and the lead tab 23 of the positive electrode 20 is bent and coupled to the groove 112 of the counterpart member 11.

Referring to FIGS. 5 and 9, the lead tab 23 of the positive electrode 20 includes the insulating tape 24 attached to the side toward the solid electrolyte. The insulating tape 24 prevents falling off of the positive electrode active materials 21 and 22 as well as a short circuit between the lead tab 23 and the solid electrolyte/negative electrode 30.

For example, the positive electrode 20 is formed by applying carbon primer layers with a thickness of 1 to 3 μm on both surfaces of the aluminum (Al) current collector 25 and applying the positive electrode active material layers 21 and 22 on the carbon primer layers.

A protrusion range of the positive electrode active material 21 toward the lead tab 23 is a maximum of 0.7 mm, and the insulating tape 24 is applied with a thickness of 10 to 30 μm and a length of 2 to 3 mm toward the lead tab 23. The insulating tape 24 attached to the surface of the positive electrode active material 21 prevents falling off of the positive electrode active material 21 and a short circuit of the first laminate 100.

Although not shown separately, an insulating tape is attached to a side of the lead tab of the negative electrode current collector toward the solid electrolyte to prevent falling off of the negative electrode active material as well as a short circuit between the lead tab of the negative electrode current collector and the positive electrode.

Note that the counterpart member 11 has a protrusion length L further protruding than the outermost surface of the solid electrolyte/negative electrode 30, and the lead tab 23 is further supported on the counterpart member 11 by the protrusion length L. In this case, the insulating tape 24 further covers the lead tab 23 on the counterpart member 11 by the protrusion length L, thereby further improving the insulating performance of the lead tab 23.

For example, the solid electrolyte/negative electrode 30 is formed by applying a negative electrode active material 34 to one surface of a negative electrode current collector 35 made of stainless steel (SUS) or nickel-coated copper (Ni-coated Cu), and laminating a solid electrolyte (SE) 36 on the negative electrode active material 34.

The negative electrode active material 34 is formed on the negative electrode current collector 35, and a solid electrolyte is formed thereon. As an example, the solid electrolyte 36 is formed of lithium argyrodite. The solid electrolyte/negative electrode sheet 30 may be laminated by direct coating of a solid electrolyte slurry, transfer of a solid electrolyte film, or lamination bonding of a free-standing solid electrolyte film and a negative electrode active material. The free-standing solid electrolyte film has a nonwoven fabric with a thickness of 15 μm therein.

In addition, the counterpart member is attached to the solid electrolyte/negative electrode by thermal pressing, resulting in a laminate of the counterpart member and the solid electrolyte/negative electrode. This laminate is laminated with a positive electrode and subjected to multi-stage pressing with a warm roll press, resulting in a bi-cell (not shown).

The counterpart member 11 is formed of a pulp-based material having electrical insulation and flame retardancy. The groove 112 is formed wider by the protrusion length L on the lead tab 23 side of the positive electrode 20 than on the lead tab 33 side of the solid electrolyte/negative electrode 30. The groove 112 has a depth corresponding to the thickness of the lead tab 23 of the positive electrode 20, thereby reducing deformation of the solid electrolyte by the lead tab 23.

For example, the buffer pad 300 is formed of a polyurethane elastomer, an acrylic elastomer, or a silicone rubber, and provides buffering power and elasticity to form flatness when lithium deposits on the negative electrode and the lithium deposited on the negative electrode dissociates during charging and discharging.

An aluminum tab and a nickel tab with insulating tape are welded to the lead tabs 23 and 33 of the positive electrode 20 and the solid electrolyte/negative electrode 30, respectively (not shown), and the buffer pads 300 are attached to the outermost surfaces of the bi-cell 200, which is vacuum-packed in an aluminum pouch to complete the all-solid-state battery 1.

Below, an all-solid-state battery 2 of a second embodiment will be described. In the second embodiment, descriptions of the same configurations as those in the first embodiment will be omitted, and only the different configurations will be described.

FIG. 10 is a cross-sectional view of an all-solid-state battery according to a second embodiment of the present invention. Referring to FIG. 10, the all-solid-state battery 2 of the second embodiment includes two counterpart members 101 and 102. The positive electrode 20 includes the positive electrode active materials 21 and 22 on both surfaces and is assembled to blanks 103 and 104.

The lead tab 23 of the positive electrode 20 is coupled to grooves 113 and 114 of the two counterpart members 101 and 102, which face each other, on both sides and is drawn out between the two counterpart members 101 and 102. In this case, the lead tab 23 is not bent.

For convenience, referring to the first embodiment, the counterpart member 11 is attached to the solid electrolyte 36 of the solid electrolyte/negative electrode 30 by thermal pressing, resulting in the first laminate 100 of the counterpart member 11 and the solid electrolyte/negative electrode 30. The first laminate 100 is laminated with the positive electrode 20 and subjected to multi-stage pressing with a warm roll press, resulting in a bi-cell 200.

The counterpart member 11 forms a gap within the tolerance range between the positive electrode active materials 21 and 22 but does not form a gap beyond the tolerance range, thereby enabling uniform pressing during roll pressing, which prevents a short circuit during charging.

If the positive electrode active materials 21 and 22 are larger than the blank 111, the counterpart member 11 is deformed, and if the positive electrode active materials 21 and 22 are smaller than the blank 111 of the counterpart member 11, a gap is formed between the counterpart member 11 and the positive electrode active materials 21 and 22. Since the solid electrolyte corresponding to the gap is pressed non-uniformly, there is no gap beyond the tolerance.

The counterpart member 11 is formed of a porous fabric and has a binder applied thereto. The porous fabric shrinks only vertically and does not elongate laterally during multi-stage roll pressing. Accordingly, since lateral elongation does not occur, the first laminate 100 is uniformly pressed, preventing a short circuit. The porous fabric prevents formation of air pockets inside during vacuum pressing. The air pockets are prevented, ensuring uniform pressing to prevent a short circuit.

The binder coated on the counterpart member 11, for example H-NBR, fixes the solid electrolyte and the counterpart member 11. In other words, the binder acts as temporary bonding during warm pressing. The temporary bonding lamination of the solid electrolyte/negative electrode 30 and the counterpart member 11 improves alignment, ensuring uniform pressing during roll pressing to prevent a short circuit.

The adhesiveness of the binder improves the adhesion between the solid electrolyte/negative electrode 30 and the positive electrode 20. If the adhesiveness of the binder is insufficient, the temporary bonding becomes unstable, and if the adhesiveness is too high, the stack transport becomes unstable. Therefore, the binder should have adhesiveness and content that minimize trade-offs with other properties.

As an experimental example, the counterpart member 11 may shrink to 50% of its initial thickness after pressing. When the pressure of the roll press is 5 tonf/cm², the thickness of the counterpart member 11 shrinks from 300 μm to 150 μm. The buffer pad 300 may be formed of acrylic foam or polyurethane foam. The thickness of the foam is 300 μm.

The diameter and length of the roll in the roll press is φ450×300 mm, the effective length is 120 mm, the line pressure is 2.0 tonf/cm, and the temperature is 120° C. The area of the temporarily bonded first laminate 100 corresponds to the area of the counterpart member 11.

The specific capacity (mAh/g) of the positive electrode active materials 21 and 22 is 200, the positive electrode active material is 85%, the mass per area (mg/cm²) is 20.56, and the current density (mAh/cm²) is 4.11. When the positive electrode 20 is pre-pressed to the maximum and subjected to the roll press, no further change in thickness occurs in the positive electrode 20.

The counterpart member sheet 10 is porous in the fabric itself, shrinks by up to 50% in thickness when pressed (for example, from 300 μm to 150 μm), and exhibits almost no elongation in the horizontal direction. The process is carried out by placing the roll press in a vacuum chamber.

TABLE 1

| | Counterpart member sheet to which positive electrode is assembled | | | | | | Roll press | | | Evaluation | | |
|---|---|---|---|---|---|---|---|---|---|---|---|---|
| | | | | counterpart member | | | Bi-cell pressing | | | | | Short |
| | positive electrode active material | | | binder (wt %) | | | | line | | | | circuit |
| | Pre- | thickness | density | | content | thickness | temp | pressure | vacuum | Stack | Production | occurrence |
| | pressing | (μm) | (g/cm3) | type | (wt %) | (μm) | (° C.) | (ton/cm) | (Torr) | process | speed | timing |
| Experimental | applied | 150 | 3.5 | H-NBR | 1 | 300 | 98 | 1.5 | 1 | ∘ | 7 | <50 |
| Example 1 | | | | | | | | | | | | |
| Experimental | applied | 150 | 3.5 | H-NBR | 5 | 300 | 98 | 1.5 | 1 | ∘ | 8 | >100 |
| Example 2 | | | | | | | | | | | | |
| Experimental | applied | 150 | 3.5 | H-NBR | 10 | 300 | 98 | 1.5 | 1 | ∘ | 9 | >200 |
| Example 3 | | | | | | | | | | | | |
| Experimental | applied | 150 | 3.5 | H-NBR | 20 | 300 | 98 | 1.5 | 1 | ∘ | 6 | <150 |
| Example 4 | | | | | | | | | | | | |
| Experimental | applied | 150 | 3.5 | PVDF-HFP | 10 | 300 | 98 | 1.5 | 1 | ∘ | 7 | <80 |
| Example 5 | | | | | | | | | | | | |
| Experimental | applied | 150 | 3.5 | Polyacrylate | 10 | 300 | 98 | 1.5 | 1 | ∘ | 6 | <100 |
| Example 6 | | | | | | | | | | | | |
| Experimental | applied | 206 | 2.5 | H-NBR | 10 | 300 | 98 | 1.5 | 1 | ∘ | 8 | <10 |
| Example 7 | | | | | | | | | | | | |
| Experimental | applied | 184 | 2.8 | H-NBR | 10 | 300 | 98 | 1.5 | 1 | ∘ | 8 | <30 |
| Example 8 | | | | | | | | | | | | |
| Experimental | applied | 172 | 3.0 | H-NBR | 10 | 300 | 98 | 1.5 | 1 | ∘ | 8 | <50 |
| Example 9 | | | | | | | | | | | | |
| Experimental | applied | 163 | 3.2 | H-NBR | 10 | 300 | 98 | 1.5 | 1 | ∘ | 8 | >100 |
| Example 10 | | | | | | | | | | | | |
| Experimental | applied | 143 | 3.7 | H-NBR | 10 | 300 | 98 | 1.5 | 1 | ∘ | 8 | <100 |
| Example 11 | | | | | | | | | | | | |
| Experimental | applied | 150 | 3.5 | H-NBR | 10 | 300 | 98 | 1.5 | 1 | ∘ | 9 | >200 |
| Example 12 | | | | | | | | | | | | |
| Experimental | applied | 150 | 3.5 | H-NBR | 10 | 300 | 80 | 1.5 | 1 | ∘ | 9 | <100 |
| Example 13 | | | | | | | | | | | | |
| Experimental | applied | 150 | 3.5 | H-NBR | 10 | 300 | 98 | 1.0 | 1 | ∘ | 8 | <150 |
| Example 14 | | | | | | | | | | | | |
| Experimental | applied | 150 | 3.5 | H-NBR | 10 | 300 | 98 | 2.0 | 1 | ∘ | 7 | <100 |
| Example 15 | | | | | | | | | | | | |
| Experimental | applied | 150 | 3.5 | H-NBR | 10 | 300 | 98 | 1.5 | 100 | ∘ | 10 | <100 |
| Example 16 | | | | | | | | | | | | |
| Comparative | not | 232 | 2.2 | not | 0 | 300 | 98 | 1.5 | 1 | ∘ | 9 | <1 |
| Example 1 | applied | | | applied | | | | | | | | |
| Comparative | applied | 150 | 3.5 | not | 0 | 300 | 98 | 1.5 | 1 | x | 3 | <1 |
| Example 2 | | | | applied | | | | | | | | |
| Comparative | applied | 150 | 3.5 | not applied | | | 98 | 1.5 | 1 | x | 3 | <1 |
| Example 3 | | | | | | | | | | | | |
| Comparative | applied | 150 | 3.5 | applied | 10 | 300 | 98 | 1.5 | not | ∘ | 9 | <1 |
| Example 4 | | | | | | | | | applied | | | |

∘: lower process difficulty,
Δ: medium process difficulty,
x: high process difficulty

Referring to Table 1, in Experimental Examples 1 to 16, the positive electrode 20 was all pre-pressed, and HNBR, PVDF-HFP, or polyacrylate was used as the binder applied to the counterpart member sheet 10. The content of the binder is 1 to 10 wt. %. The counterpart member 11 is formed of acrylic foam or polyurethane foam with a thickness of 300 μm. The roll press conditions are the temperature of 80 to 100° C., the line pressure of 1 to 2.0 tonf/cm, and vacuum of 1 to 10 Torr.

In Experimental examples 1 to 16, evaluation was conducted by whether to apply pre-pressing to the positive electrode 20, changing the type, content, and thickness of the binder in the counterpart member 11, and changing the temperature, line pressure, and vacuum during the roll press.

In the Comparative Examples, the pre-pressing was not applied to the positive electrode, the counterpart member sheet was not applied, or the vacuum was not applied during roll pressing. It can be seen from the Comparative Examples that the pre-pressing should be applied to the positive electrode and it is difficult to overcome the short circuit when the counterpart member and the vacuum are not applied.

In the Comparative Examples, the pre-pressing was applied or not applied to the positive electrode, the counterpart member sheet was applied or not applied, the binder was applied or not applied, and the vacuum was applied or not applied during roll pressing.

Therefore, in the Comparative Examples, pre-pressing was not applied to the positive electrode 20 and the binder was not applied to the counterpart member (Comparative Example 1), the binder was not applied to the counterpart member (Comparative Examples 2 and 3), and the vacuum was not applied (Comparative Example 4), resulting in a short-circuit occurrence timing of less than one cycle.

In contrast, in the Experimental Examples, the pre-pressing was applied to the positive electrode 20, the binder was applied to the counterpart member 11, and the vacuum was applied, resulting in a short-circuit occurrence timing of at least 10 cycles and on average more than 100 cycles.

In conclusion, it can be seen that it is necessary to apply pre-pressing to the positive electrode 20, apply the binder to the counterpart member 11, and apply the vacuum so as to increase the short-circuit occurrence timing applicable to the charge and discharge evaluation.

The all-solid-state battery 1 containing the sulfide solid electrolyte 36 requires specific pressing during manufacturing and charge/discharge evaluation. Therefore, the physical defects and non-uniformities within the battery cell act as causes of short circuits. Therefore, pre-pressing of the positive electrode 20 and application of the counterpart member sheet 10 improve the short circuits.

In addition, when the roll pressing was applied, the counterpart member sheet 10 enabled uniform pressing. It was confirmed that by pre-pressing the positive electrode 20, optimizing the counterpart member sheet 10 and the binder, and performing the roll pressing in a vacuum chamber, it is possible to manufacture a long-life all-solid-state battery 1 with a short-circuit occurrence timing of 200 cycles or more, even with the roll press method.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

(Reference Signs List)

| | |
|---|---|
| 1, 2: all-solid-state battery | 10: counterpart member sheet |
| 11: counterpart member | 13: pre-cut portion |
| 14: uncut portion | 15: separation portion |
| 20: positive electrode | 21, 22: positive electrode active material |
| 23, 33: lead tab | 24: insulating tape |
| 25: current collector | 30: solid electrolyte/negative electrode sheet |

31: first solid electrolyte/negative electrode sheet
32: second solid electrolyte/negative electrode sheet

| | |
|---|---|
| 34: negative electrode active material | 36: solid electrolyte |
| 35: negative electrode current collector | 100: first laminate |
| 103, 104: blank | 101, 102: counterpart member |
| 111: blank | 112: groove |
| 113, 114: groove | 211, 212: counterpart member sheet |
| 200: bi-cell | 300: buffer pad |
| 400: second laminate | L: protrusion length |

1. A method for manufacturing an all-solid-state battery, comprising:
a first step of supplying, in a reel type, a counterpart member sheet in which counterpart members, each having a blank corresponding to a positive electrode of a battery cell, are partitioned with repeating pre-cut portions and uncut portions;
a second step of arranging a magazine-type positive electrode in the blanks;
a third step of supplying, in a reel type, a first solid electrolyte/negative electrode sheet and a second solid electrolyte/negative electrode sheet to upper and lower portions of the counterpart member sheet to which the positive electrode is assembled, each of the first solid electrolyte/negative electrode sheet and the second solid electrolyte/negative electrode sheet being formed by attaching a solid electrolyte and a negative electrode;
a fourth step of performing temporary bonding lamination on the first solid electrolyte/negative electrode sheet, the counterpart member sheet to which the positive electrode is assembled, and the second solid electrolyte/negative electrode sheet; and
a fifth step of pressing and cutting a temporarily bonded laminated first laminate to separate bi-cells.

2. The method of claim 1, further comprising
a sixth step of alternately laminating the bi-cells and buffer pads to form a second laminate.

3. The method of claim 2, further comprising
a seventh step of welding lead tabs of the positive electrodes to each other and welding lead tabs of the negative electrodes to each other in the second laminate, and inserting the second laminate into a case to complete a stack.

4. The method of claim 1, wherein
in the first step,
the reel-type counterpart member sheet is supplied with the pre-cut portions on both sides in a direction intersecting an advancing direction of the counterpart member sheet.

5. The method of claim 1, wherein
in the first step, the counterpart member sheet is supplied as a single sheet, and
wherein in the second step,
a lead tab of a positive electrode assembled to the blank of the single sheet is coupled to a groove of the counterpart member, the positive electrode comprising positive electrode active materials on both surfaces.

6. The method of claim 5, wherein
in the second step,
an insulating tape is attached to a side of the lead tab of the positive electrode toward the solid electrolyte.

7. The method of claim 1, wherein
in the first step, the counterpart member sheet is supplied as two sheets, and
wherein in the second step,
a lead tab of a positive electrode assembled to each of the blanks of the two sheets is coupled to grooves of two counterpart members facing each other and drawn out between the two counterpart members, the positive electrode comprising positive electrode active materials on both surfaces.

8. The method of claim 1, wherein
in the fourth step,
alignment and then temporary bonding lamination are performed with a hybrid combination of reel to sheet and magazine.

9. The method of claim 1, wherein
in the fifth step,
the first laminate is pressed using a roll press.

10. An all-solid-state battery comprising a bi-cell, the bi-cell comprising:
a counterpart member having a blank;
a positive electrode formed corresponding to the blank of the counterpart member and arranged in the blank; and
a solid electrolyte/negative electrode bonded to each other so as to be adhered to the positive electrode with a solid electrolyte, wherein
the counterpart member
comprises an outer separation portion separated by a cut connecting a pre-cut portion and an uncut portion in an uncut state.

11. The all-solid-state battery of claim 10,
comprising a laminate comprising a plurality of the bi-cells and a plurality of buffer pads and formed by alternately laminating the bi-cells and the buffer pads.

12. The all-solid-state battery of claim 11, wherein:
in the laminate, lead tabs of the positive electrodes are welded to each other, and lead tabs of the negative electrodes are welded to each other.

13. The all-solid-state battery of claim 10, wherein:
the counterpart member comprises
the pre-cut portions on both sides in a direction in which a lead tab of the positive electrode and a lead tab of the negative electrode are drawn out and on both sides in a direction intersecting the drawing direction, and
the separation portion at corners intersecting outer edges connecting to the pre-cut portions.

14. The all-solid-state battery of claim 10, wherein:
the counterpart member is formed as a single member,
wherein the positive electrode comprises positive electrode active materials on both surfaces and is assembled to the blank, and
wherein a lead tab of the positive electrode is coupled to a groove of the counterpart member and bent.

15. The all-solid-state battery of claim 14, wherein:
the lead tab of the positive electrode further comprises
an insulating tape attached to a side toward the solid electrolyte.

16. The all-solid-state battery of claim 10, wherein:
the counterpart member is formed as two members,
wherein the positive electrode comprises positive electrode active materials on both surfaces and is assembled to the blank, and
wherein a lead tab of the positive electrode is coupled to grooves of the two counterpart members facing each other and drawn out between the two counterpart members.

17. The all-solid-state battery of claim 10, wherein:
the counterpart member further comprises
an adsorption flame retardant film comprising a pulp fiber, a glass fiber, Al(OH)₃, and a binder.

18. The all-solid-state battery of claim 17, wherein:
the binder comprises
at least one of H-NBR, PVDF-HFP, and polyacrylate.

19. The all-solid-state battery of claim 17, wherein:
the adsorption flame retardant film is
coated on both surfaces of the counterpart member.

20. The all-solid-state battery of claim 18, wherein:
a content of the binder is 1 to 20 wt %.

21. The all-solid-state battery of claim 18, wherein:
a content of the binder is 5 to 10 wt %.
